(19) United States
(12) Patent Application Publication
(10) Pub. No.: US 2010/0089134 A1
(43) Pub. Date: Apr. 15, 2010

(54) HPLC PUMPING APPARATUS WITH SILICON CARBIDE PISTON AND/OR WORKING CHAMBER

(75) Inventor: Hans-Georg Haertl, Waldbronn (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Santa Clara, CA (US)

(21) Appl. No.: 12/526,390

(22) PCT Filed: Feb. 14, 2007
(86) PCT No.: PCT/EP2007/051437

§ 371 Date: Aug. 7, 2009

(51) Int. Cl. G01N 30/02; F04B 53/14; B01D 15/18

(52) U.S. Cl. 73/61.55; 92/172; 92/249; 210/136

(57) ABSTRACT

A pumping apparatus for a high performance liquid chromatography system (350) is disclosed. The pumping apparatus comprises a piston (1) for reciprocation in a pump working chamber (3) to compress liquid in the pump working chamber (3) to a high pressure at which compressibility of the liquid becomes noticeable. At least one of the piston (1) and the pump working chamber (3) is at least partially coated with or comprised of silicon carbide.

The present invention relates to a pumping apparatus in a high performance liquid chromatography system, wherein liquid is compressed to a high pressure at which compressibility of the liquid becomes noticeable.

### BACKGROUND ART

In high performance liquid chromatography (HPLC), a liquid has to be provided usually at very controlled flow rates (e. g. in the range of microliters to milliliters per minute) and at high pressure (typically 200-1000 bar and beyond up to currently even 2000 bar) at which compressibility of the liquid becomes noticeable. Piston- or plunger pumps usually comprise one or more pistons arranged to perform reciprocal movements in a corresponding pump working chamber, thereby compressing the liquid within the pump working chamber(s). The reciprocation is repeated thousand fold during the lifetime of the pump, thereby causing wear, abrasion and, hence, changes of the material and surface properties to the piston.

A liquid chromatography pumping system is described in EP 0309596 B1 by the same applicant, Agilent Technologies, depicting a pumping apparatus comprising a dual piston pump system for delivering liquid at high pressure for solvent delivery in liquid chromatography.

In HPLC applications, the pumping apparatus is exposed to more or less aggressive solvents ranging typically from water, Acetonitrile, Tetrahydrofurane, Methanol to Hexane or n-Hexane. Analytic HPLC applications usually work at flow rates of about 0.01 ml/min-10 ml/min, and applications in semi-preparative HPLC often work at flow rates of about 05-100 ml/min. Pistons of pumping apparatuses in HPLC applications are usually made of oxide ceramics (such as zirconia ZrO₂) or crystalline sapphire Al₂O₃, having proved—over decades—excellent characteristics and long life behavior for most HPLC applications.

### DISCLOSURE

It is an object of the invention to provide an improved pumping apparatus. The object is solved by the independent claims. Further embodiments are shown by the dependent claims.

According to embodiments of the present invention, a pumping apparatus is described which is adapted to deliver liquids under high pressure in a high performance liquid chromatography system, in particular for analysis of chemical or biochemical compounds. The pumping apparatus is composed of one or more pistons, each of which being movably arranged in a corresponding pump working chamber. Moving a piston can be performed by a drive unit preferably having a piston holder. Each piston compresses the liquid in the respective pump working chamber to a high pressure at which compressibility of the liquid becomes noticeable.

While pistons in HPLC applications are usually made of oxide ceramics or crystalline sapphire, which have proved—over decades of HPLC developments—an excellent characteristic and long life behavior, it has been found that an entire different material, silicon carbide, revealed a surprising characteristic and unexpected suitability for the quite rough and severe requirements, in particular high pressure and aggressive solvents, in HPLC. Accordingly, embodiments of the present invention use silicon carbide (SiC) as material for the piston and/or the pump working chamber, or parts thereof, wherein such components are either at least partially coated or even comprised as solid material. Preferably, the silicon carbide is used as sintered silicon carbide (SSiC) material.

It has been shown that, for example, pistons made of a solid material of sintered silicon carbide exhibited a low friction coefficient, hardness of about 9.5, electrical conductivity of about 10³ Ωm, chemical inertness even at higher temperatures up to 140° C., and a good mechanical stability for the HPLC requirements. Such SSiC pistons have even proved to be suitable for preparative HPLC applications using n-hexane as solvent, which represents one of the most severe requirements for HPLC pumping systems.

SSiC tends to be a brittle material and can usually withstand a high pressure load, but as most brittle materials it might show limitations under torsion and strain. Depending on the load either coating or solid SSiC may be of advantage.

Each reciprocation cycle of the piston provides liquid compression, with the plurality of reciprocation cycles demanding an increased material resistance in particular with respect to piston wear. The piston and/or the working chamber, or parts thereof, made of (preferably sintered) silicon carbide or being coated therewith provide/s an improved wear resistance and reduced abrasion of the piston.

In one embodiment, the pumping apparatus is coupled with another pumping apparatus, whereby both pumping apparatuses might be embodied in the same way but may also be different. At least one and preferably both of the pumping apparatuses are embodied in accordance with embodiments of the present invention. Providing two pumping apparatuses allows providing an essentially continuous liquid flow, as well known in the art and also explained in detail in the aforementioned EP 309596 A1. Such so called dual pump might comprise the two pumping apparatuses in either a serial or a parallel manner.

In the serial manner, as disclosed in the aforementioned EP 309596 A1, the outlet of one pumping apparatus is coupled to the inlet of the other pumping apparatus. The teaching in the EP 309596 A1 with respect to the operation and embodiment of such serial dual pump shall be incorporated herein by reference. The pump volume of the first pumping apparatus might be embodied to be larger than (e.g. twice of) the pump volume of the second pumping apparatus, so that the first pumping apparatus will supply a portion of its pump volume directly into the system and the remaining portion to supply the second pumping apparatus, which will then supply the system during the intake phase of the first pumping apparatus. The ratio of the pump volume of the first pumping apparatus to the second pump apparatus is preferably 2:1, but any other meaningful ratio might be applied accordingly.

In the parallel manner, the inlets and the outlets, respectively, of both pumping apparatuses are coupled together. The inputs are preferably coupled in parallel to a liquid supply, and the outputs are preferably coupled in parallel to a succeeding system receiving the liquid at the high pressure. The two pumping apparatuses might be operated e.g. with substantially 180 degree phase shift, so that only one pumping apparatus is supplying into the system while the other is intaking liquid (e.g. from the supply). However, it is clear that also both pumping apparatuses might be operated in parallel (i.e. concurrently), at least during certain transitional phases e.g. to provide a smooth(er) transition of the pumping cycles between the pumping apparatuses.

In both manners, serial and parallel, operation of the two pumping apparatuses is phase shifted, usually and preferably by about 180 degrees. The phase shifting might be varied in order to compensate pulsation in the flow of liquid as resulting from the compressibility of the liquid. It is also known to use three piston pumps having about 120 degrees phase shift.

Embodiments of the afore described pumping apparatus are preferably applied in a liquid separation system comprising a separating device, such as a chromatographic column, having a stationary phase for separating compounds of a sample liquid in a mobile phase. The mobile phase is driven by the pumping apparatus. Such separation system might further comprise at least one of a sampling unit for introducing the sample fluid into the mobile phase, a detector for detecting separated compounds of the sample fluid, a fractionating unit for outputting separated compounds of the sample fluid, or any other device or unit applied in such liquid separation systems.

### DETAILED DESCRIPTION

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

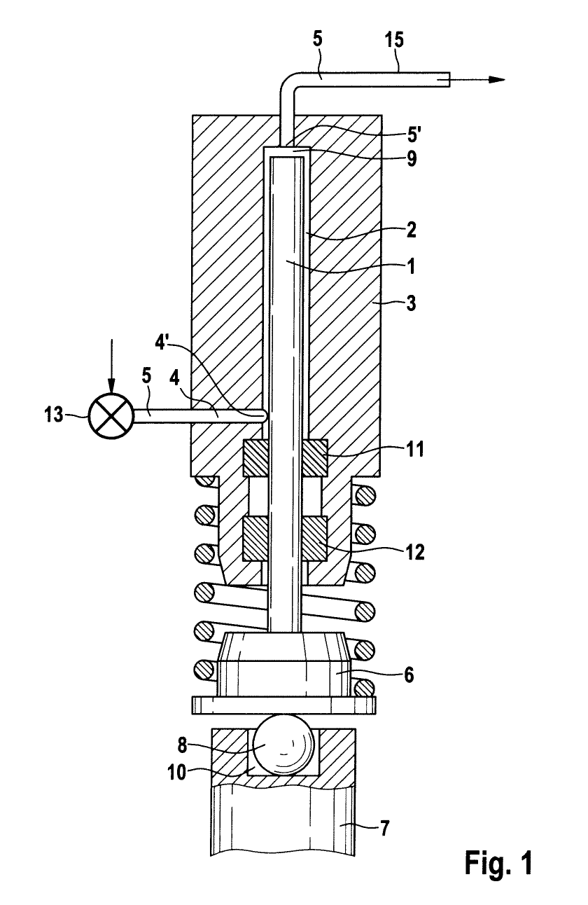

FIG. 1 schematically shows a pumping apparatus comprising a coated piston.

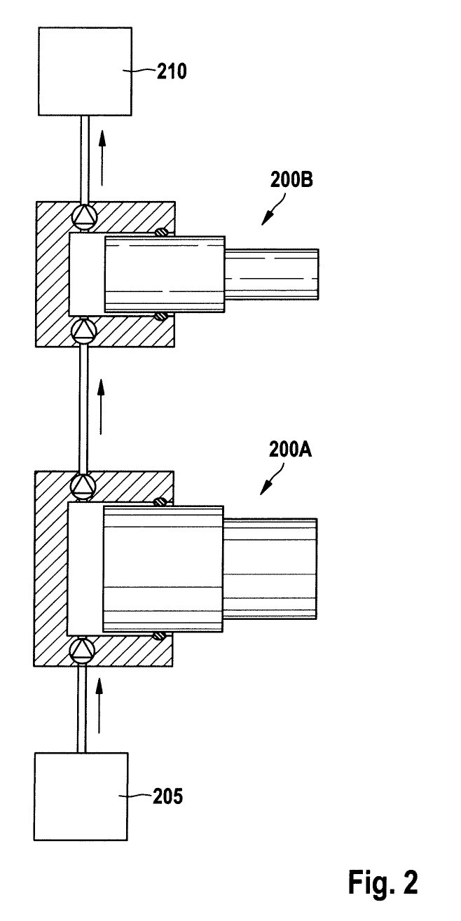

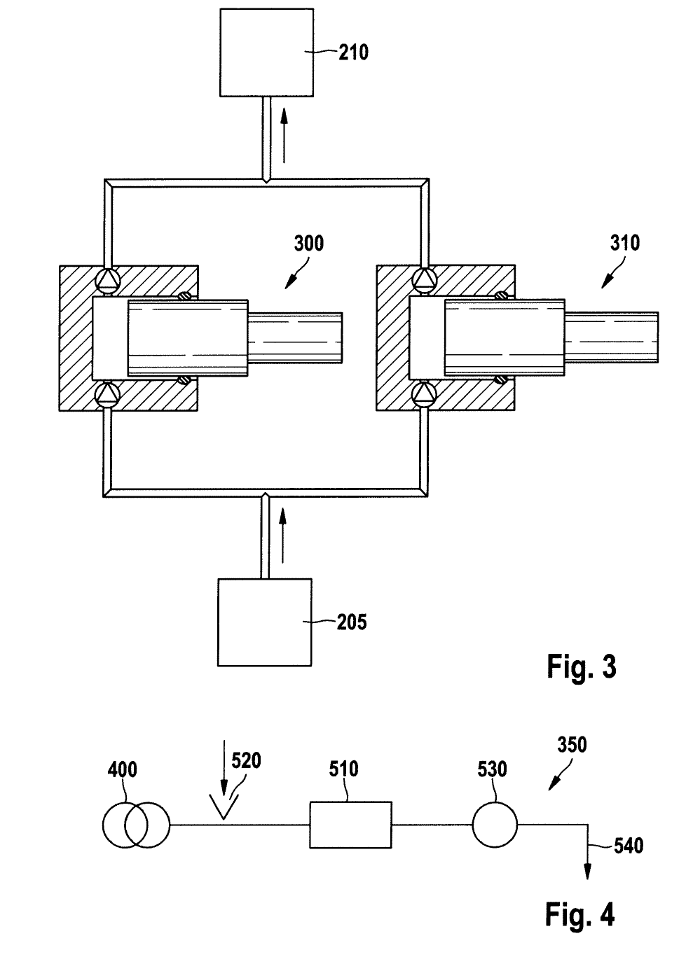

FIG. 2 shows a dual serial and FIG. 3 a dual parallel pumping apparatus.

FIG. 4 shows a liquid separation system 500.

Pumping apparatuses for delivering liquid at a high pressure shall first be described in more general terms. The pressure applied by the piston provides a noticeable compression of the liquid. The piston of the pumping apparatus is reciprocated in the pump working chamber containing the respective liquid. The pump working chamber may be coupled to one or more valves in order to permit liquid flow unidirectional only. Driving the piston may be performed by a drive unit which permits pressurizing of the liquid in the pump working chamber to high pressure. Advantageously, silicon carbide (preferably sintered) is used as material for the piston and/or the pump working chamber, or parts thereof. Such components might be at least partially coated by the silicon carbide or even be comprised as solid material parts of silicon carbide.

FIG. 1 depicts an embodiment of a pumping apparatus comprising a piston 1 reciprocating in a pump working chamber 9 formed by a cylindrical inner bore of a pump cylinder body 3. The pump working chamber 9 has an inlet port 4′ and an outlet port 5′. A capillary 5 having an inner bore 4 is coupled to the inlet port 4′ and also couples an inlet valve 13 with the pump working chamber 9 to permit liquid flow only unidirectional into the pump working chamber 9. The reciprocating movements are driven by a drive unit (not shown herein—e.g. as disclosed in the aforementioned EP 309596 A1), which operates the piston 1 in a spindle drive manner via an actuator 7 coupled e.g. via a ball 8 (embedded in a recess 10) and a piston holder 6.

A seal 11 is provided for sealing off the pump working chamber 9 at an opening in the pump cylinder body 3 where the piston 1 moves into the pump working chamber 9. Thus, unwanted liquid flow-out (towards the drive) can be prevented. Guiding of the piston 1 into the pumping chamber 9 can be supported by a guiding element 12.

The liquid in the pump working chamber 9 is compressed to a high pressure before being delivered via the outlet port 5′ and the capillary 5 (having an inner bore 15) into a liquid receiving device (not shown in FIG. 1).

Generally, wear and abrasion are well known phenomena causing material destruction in driving units, pumps and other devices. The piston 1 performs the reciprocating movement manifold during its lifetime and is subjected to abrasion due to friction loading, accordingly risking to be damaged from wear.

Further, the working chamber as well as the piston are exposed to more or less aggressive solvents as the mobile phase to be compressed by the pumping apparatus. Accordingly, the piston 1 and/or the pump working chamber 9, or parts thereof, are made of silicon carbide, preferably SSiC, and/or at least partly coated with. In the embodiment of FIG. 1, the piston 1 is a solid material body of SSiC.

In another embodiment, the piston 1 has a solid material body made of a material such as sapphire, ceramics, tungsten carbide, or metals (such as steel), and is (at least partly) coated with silicon carbide. In embodiments, the SiC coating has a thickness ranging from 0.1 to 10 micrometer, a preferred range of thickness is 0.2 to 5 micrometer, depending e.g. on the piston base material and typical application of the piston.

Typical solvents, as used in the pumping apparatus as shown in FIG. 1, can be water, Acetonitril, Tetrahydrofurane, Methanol, Hexane or any other solvents used in HPLC.

In the serial dual pump of FIG. 2, a first pumping apparatus 200A is coupled at its input to a liquid supply 205, and its output is coupled to the input of a second pumping apparatus 200B. At least one and preferably both of the pumping apparatuses 200A and 200B are embodied in accordance with the aforementioned embodiments. In order to provide a continuous flow of liquid, the pump volume of the first pumping apparatus 200A might be embodied larger than the pump volume of the second pumping apparatus 200B, so that the first pumping apparatus 200A will supply a portion of its pump volume directly into a system 210 and the remaining portion to supply the second pumping apparatus 200B, which will then supply the system during the intake phase of the first pumping apparatus 200A. The ratio of the pump volume of the first pumping apparatus 200A to the second pump apparatus 200B is preferably 2:1, but any other meaningful ratio might be applied accordingly. Further details of the operation mode of such dual serial pump are disclosed in the aforementioned EP 309596 A1 and shall be incorporated herein by reference.

In the parallel dual pump of FIG. 3, the inputs of a first pumping apparatus 300 and a second pumping apparatus 310 are coupled in parallel to the liquid supply 205, and the outputs of the two pumping apparatuses 200C and 200D are coupled in parallel to the system 210 receiving the liquid at high pressure. The two pumping apparatuses 300 and 310 are operated usually with substantially 180 degree phase shift, so that only one pumping apparatus is supplying into the system while the other is intaking liquid from the supply 205. However, it is clear that also both pumping apparatuses 300 and 310 might be operated in parallel (i.e. concurrently), at least during certain transitional phases e.g. to provide a smooth(er) transition of the pumping cycles between the pumping apparatuses.

FIG. 4 shows a liquid separation system 350. A pump 400, which might be embodied as illustrated in FIGS. 1-3, drives a mobile phase through a separating device 510 (such as a chromatographic column) comprising a stationary phase. A sampling unit 520 is provided between the pump 400 and the separating device 510 in order to introduce a sample fluid to the mobile phase. The stationary phase of the separating device 510 is adapted for separating compounds of the sample liquid. A detector 530 is provided for detecting separated compounds of the sample fluid. A fractionating unit 540 can be provided for outputting separated compounds of sample fluid.

Further details of such liquid separation system 500 are disclosed with respect to the Agilent 1200 Series Rapid Resolution LC system or the Agilent 1100 HPLC series, both provided by the applicant Agilent Technologies, under www.agilent.com which shall be in cooperated herein by reference.

1. A pumping apparatus for a high performance liquid chromatography system, the pumping apparatus comprising
a piston for reciprocation in a pump working chamber to compress liquid in the pump working chamber to a high pressure at which compressibility of the liquid becomes noticeable,
wherein at least one of the piston and the pump working chamber is at least partially coated with or comprised of silicon carbide.

2. The pumping apparatus of claim 1, wherein the silicon carbide is a sintered silicon carbide material.

3. The pumping apparatus of claim 1, comprising a valve, coupled to the pump working chamber, to permit liquid flow only unidirectional, wherein the valve preferably is an inlet valve.

4. The pumping apparatus of claim 1, comprising a drive unit for reciprocating the piston, wherein the drive unit preferably comprises a piston holder to which the piston is mounted.

5. The pumping apparatus of claim 1, wherein the piston is coated with silicon carbide, the piston being made of a material of a group comprising: sapphire, ceramic, tungsten carbide, metal, steel.

6. The pumping apparatus of claim 1, wherein the piston is coated with silicon carbide, the coating having a thickness ranging from 0.1 to 10, preferably from 0.2 to 5, micrometer.

7. The pumping apparatus according to claim 1, comprising at least one of:
the high pressure ranges from 200 to 2000 bar, in particular 600 to 1200 bar;
the liquid is pumped at a selectable flow rate;
the pump working chamber has an inlet port and an outlet port.

8. The pumping apparatus of claim 1, as a first pumping apparatus, further comprising
a second pumping apparatus, preferably of claim 1,
wherein both pumping apparatuses are coupled either
in a serial manner, with an outlet of the first pumping apparatus being coupled to an inlet of the second pumping apparatus, and an outlet of the second pumping apparatus providing an outlet of the pump, or
in a parallel manner, with an inlet of the first pumping apparatus being coupled to an inlet of the second pumping apparatus, and an outlet of the first pumping apparatus being coupled to an outlet of the second pumping apparatus, thus providing an outlet of the pump; and
a liquid outlet of the first pumping apparatus is phase shifted, preferably essentially 180 degrees, with respect to a liquid outlet of the second pumping apparatus.

9. A high performance liquid chromatography system, comprising:
a separating device comprising a stationary phase for separating compounds of a sample fluid comprised in a mobile phase, and a pumping apparatus of claim 1, adapted for driving a mobile phase through the separating device.

10. The separation system of claim 9, comprising at least one of:
a sampling unit adapted for introducing the sample fluid to the mobile phase,
a detector adapted for detecting separated compounds of the sample fluid,
a fractionating unit adapted for outputting separated compounds of the sample fluid.
